(19) United States
(12) Patent Application Publication
(10) Pub. No.: US 2014/0183134 A1
(43) Pub. Date: Jul. 3, 2014

(54) FORWARD OSMOSIS AND PRESSURE RETARDED OSMOSIS SPACER

(71) Applicant: HYDRATION SYSTEMS, LLC, Scottsdale, AZ (US)

(72) Inventor: John R. Herron, Corvallis, OR (US)

(21) Appl. No.: 13/843,237

(22) Filed: Mar. 15, 2013

Related U.S. Application Data
(60) Provisional application No. 61/748,386, filed on Jan. 2, 2013.

(51) Int. Cl. B01D 69/10; C02F 1/44

(52) U.S. Cl. CPC B01D 69/10; C02F 1/445; C02F 1/441
USPC 210/644; 210/541; 210/486; 210/652; 210/457

(57) ABSTRACT

Described herein is a structure for a permeate spacer for use in spiral wound osmosis membrane elements, having at least two sets of parallel ribs, wherein the ribs in the first set are oriented at about a 90 degree angle to the ribs in the second set. The permeate spacer is used by sandwiching it inside a membrane envelope or leaf, and is particularly useful for non-pressure-driven processes, such as forward osmosis (FO) and pressure-reduced osmosis (PRO).

### CROSS REFERENCE TO RELATED APPLICATION

This application claims priority to U.S. provisional application Ser. No. 61/748,386 filed Jan. 2, 2013, the entire disclosure of which is hereby incorporated by reference.

### FIELD OF THE INVENTION

The invention relates to permeate spacers for use in spiral wound membrane elements or modules for use in osmotic filtration processes.

### BACKGROUND OF THE INVENTION

Permeate spacers in spiral wound membrane elements for use in pressure-driven osmosis processes are generally made to allow the fluid which permeates the membrane (referred to as “permeate”) to flow, within an envelope formed by the membranes, to a center tube. The flow within the envelope is in one direction only, spiraling inward to the center tube. Typically, channels for the flow are provided by sandwiching a ribbed fabric permeate spacer inside the membrane envelope. The ribs of the fabric are oriented toward (perpendicular with) the center tube; the ribs spiral outward from the center tube, to provide low flow resistance inward toward the center tube

Forward osmosis (FO) and pressure retarded osmosis (PRO) differ from pressure driven osmotic filtration processes in part because they require two separate feed solutions. One feed solution is fed axially to the outside of the membrane envelope as in a standard spiral wound filtration element, while the other feed solution is forced to flow within/through the membrane envelope. The method for directing the second feed solution flow, and the structure of a membrane envelope, also known as a membrane leaf, are described in U.S. Pat. No. 4,033,878 (Foreman, et al.) and are shown in FIG. 1.

Referring to FIG. 1, the membrane envelope 2 comprises the following components: center tube 20, holes 21 in center tube 20 (through which fluid flows from the center tube into the membrane envelope), plug 22 in center tube 20, glue line 24 at the perimeter of and defining the membrane envelope, and center glue line 26. The arrow labeled “A” in FIG. 1 is a schematic representation of the direction of flow of draw solution within the membrane envelope. Arrow “X” and Arrow “Y” respectively represent the flow of fluid into and out of the center tube and membrane envelope.

### SUMMARY OF THE INVENTION

Described herein is a new structure for a permeate spacer for use in spiral wound osmosis membrane elements. The permeate spacer described herein works well in non-pressure-driven osmotic processes. The permeate spacer has a first set of parallel ribs which run substantially parallel to the center glue line and substantially perpendicular to the center tube, and also has a second set of parallel ribs which run perpendicular to the ribs in the first set. The permeate spacer is used by sandwiching it inside the membrane envelope or leaf. The permeate spacer disclosed herein is useful in membrane envelopes for spiral wound membrane elements, particularly for those used in non-pressure-driven processes, such as forward osmosis (FO) and pressure-reduced osmosis (PRO).

### BRIEF DESCRIPTION OF THE DRAWINGS

FIG. 1 is a schematic illustration of a membrane envelope, showing the draw flow of permeate in a forward osmosis membrane element.

FIG. 2 is a schematic illustration of a membrane envelope having a ribbed permeate spacer according to the prior art, showing the draw flow of permeate in a forward osmosis membrane element.

FIG. 3 is a schematic illustration of a membrane envelope having a ribbed permeate spacer according to an embodiment of the invention, showing the draw flow of permeate in a forward osmosis membrane element.

FIG. 4 is a front view of a permeate spacer according to an embodiment of the invention.

FIG. 5 is a back view of a permeate spacer according to an embodiment of the invention.

FIGS. 6A, 6B, 6C and 6D are illustrations of left side, right side, top and bottom views of a permeate spacer according to an embodiment of the invention.

FIG. 7 is an exploded view of a permeate spacer according to an embodiment of the invention.

### DETAILED DESCRIPTION OF THE INVENTION

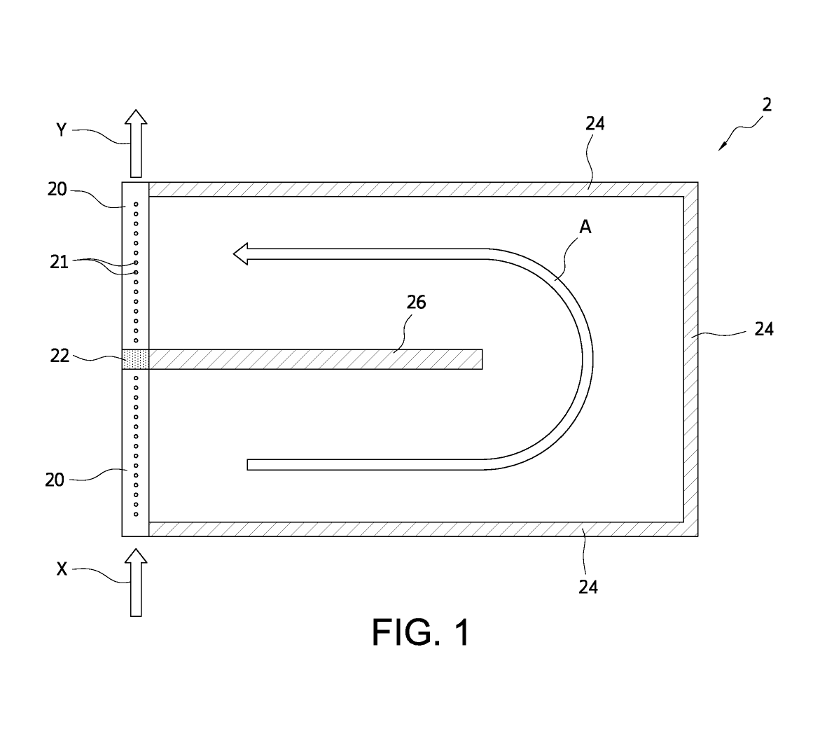

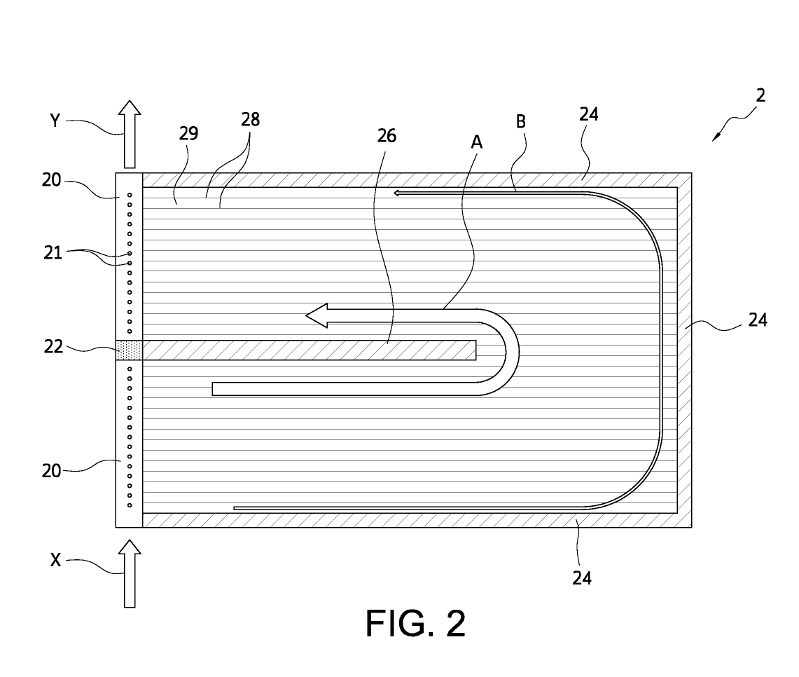

FIG. 2 is an illustration of the draw flow in a membrane envelope 2 having a ribbed permeate spacer according to the prior art. The components shown in FIG. 2 are the same as shown in FIG. 1, except for the ribs 28 of the ribbed permeate spacer. Each couple of raised ribs 28 defines a lower profile channel 29 between the ribs. Fluid within the membrane envelope primarily flows within the channels defined by the ribs. The majority of the volume of flow is concentrated in the ribs near the center glue line 26 and is indicated by the arrow labeled “A” in FIG. 2. In contrast, a far smaller volume of flow occurs at the perimeter of the element, and is indicated by the arrow labeled “B” in FIG. 2. The flow represented by “A” in FIG. 2 is at a much higher velocity than the flow represented by “B” in FIG. 2. Arrow “X” and Arrow “Y” respectively represent the flow of fluid into and out of the center tube 20 and the membrane envelope 2.

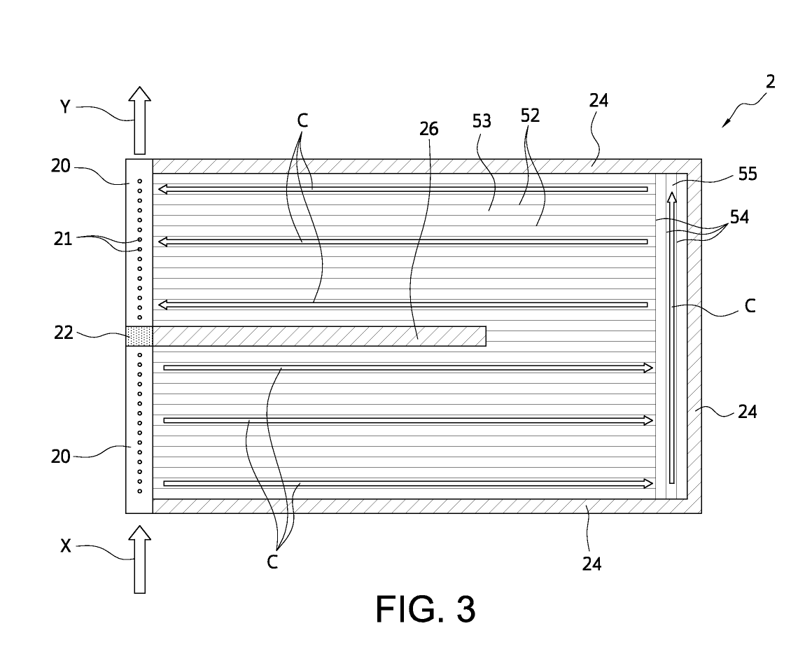

FIG. 3 illustrates the flow of permeate in a membrane envelope 2 that has been provided with a permeate spacer according to the invention. Arrow “X” and Arrow “Y” respectively represent the flow of fluid into and out of the center tube and membrane envelope. As illustrated by the arrows labeled “C” in FIG. 3, the permeate spacer of the present invention evenly distributes the flow of draw solution throughout the membrane envelope 2, by slowing down the flow of draw solution near the center glue line 26, facilitating good flow of draw solution in the outer corners of the membrane envelope and causing the draw flow within the envelope to more easily change direction within the envelope. The permeate spacer of the invention provides a way to permit a relatively even flow, in terms of flow pattern and velocity of flow, of draw solution throughout the membrane envelope without resulting in significant pressure drops in the flow. The permeate spacer design directs flow of draw solution within the membrane envelope to the corners of the envelope. Accordingly, the spacer of the invention is ideally suited for use in osmotic processes such as forward osmosis (FO) and pressure retarded osmosis (PRO).

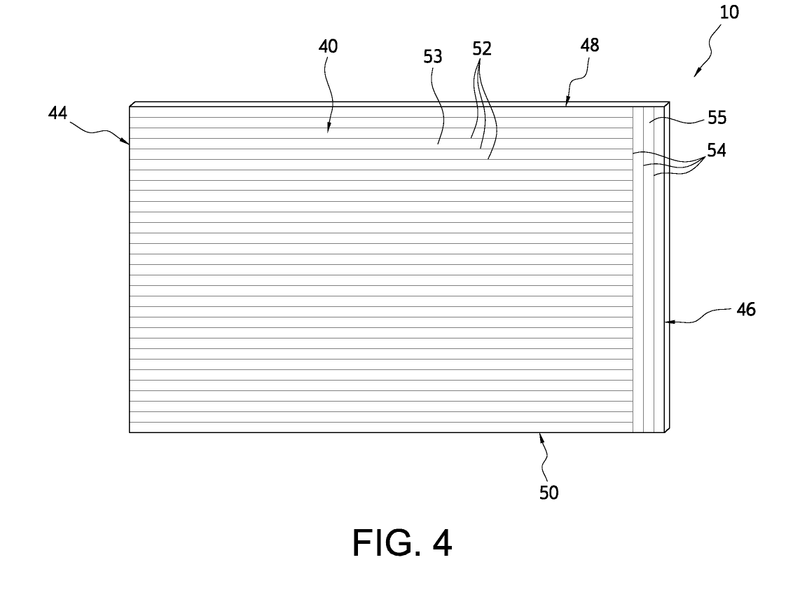

FIG. 4 is a front view of an embodiment of a permeate spacer according to the invention.

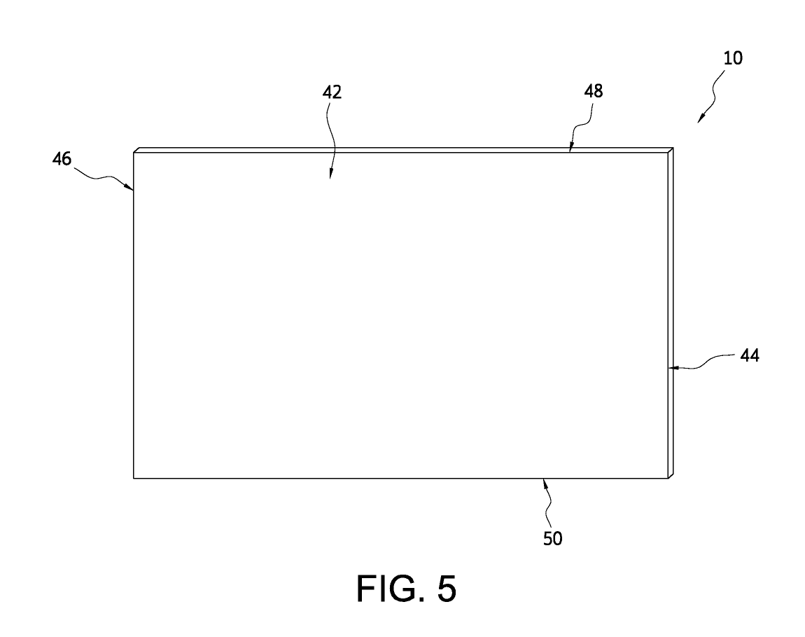

FIG. 5 is a back view of an embodiment of a permeate spacer according to the invention. In the embodiment shown in FIG. 5, the back surface does not have ribs.

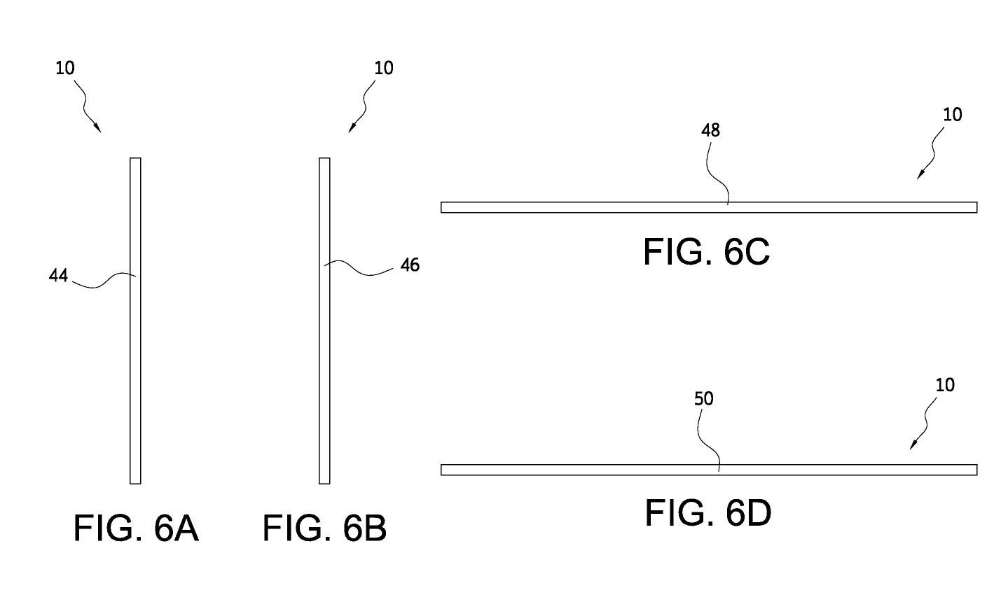

FIGS. 6A through 6D comprise side, top and bottom views of the embodiment of a permeate spacer 10 according to the invention shown in FIGS. 4 and 5. FIG. 6A is a left side view, FIG. 6B is a right side view, FIG. 6C is a top view, and FIG. 6D is a bottom view.

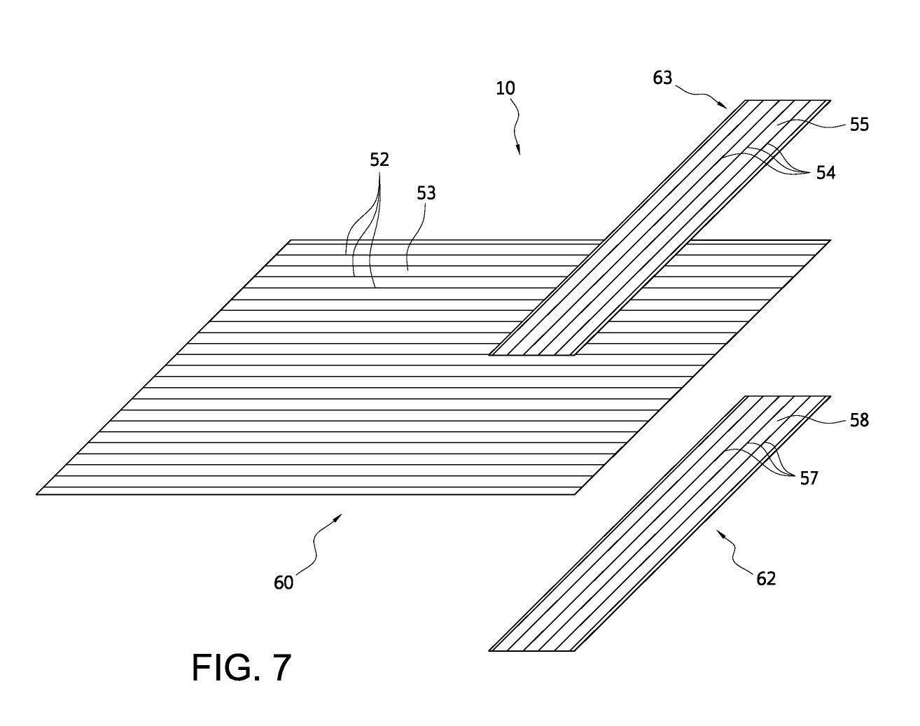

FIG. 7 shows an exploded view of an embodiment wherein the permeate spacer 10 of the invention has at least a first set of ribs 52, and at least a second set of ribs 54, wherein the first and second sets are oriented so that the ribs in the first set of ribs are perpendicular to the ribs in the second set of ribs.

The permeate spacer of the invention has a first set of ribs 52, wherein the ribs are substantially parallel to one another. Each couple of two raised ribs 52 defines a lower profile channel 53 between the ribs. Fluid within the membrane envelope flows within the channels 53 defined by the ribs 52. Preferably, the ribs are evenly spaced apart. The distance between the ribs is in the range of about 0.3 to about 2 mm, with all of the ribs in the first set of ribs spaced about equidistantly apart. The permeate spacer has a thickness in the range of about 0.3 to about 2 mm as measured by the distance between its first and second faces.

As shown in FIG. 3, when the permeate spacer is in use in a membrane envelope 2, the ribs 52 in the first set of ribs are oriented substantially parallel to the center glue line 26 of the membrane envelope 2 and substantially perpendicular to the longitudinal axis of the center tube 20 of the membrane element 2. The first set of ribs may be comprised of a first sheet of ribbed permeate spacer fabric.

As illustrated in FIG. 3, the permeate spacer of the invention has a second set of ribs that are oriented substantially perpendicular, wherein each rib 54 in the second set is substantially parallel to one another. Each couple of two raised ribs 54 defines a lower profile channel 55 between the ribs. Fluid within the membrane envelope 2 flows from the center rube 20 via channels 53 (substantially on one side of glue line 26) to channels 55, and then fluid flows back to the center tube 20 via channels 53 (on the other side of glue line 26). Preferably, the ribs in the second set of ribs are evenly spaced apart. The distance between the ribs is in the range of about 0.3 to about 2 mm, with all of the ribs in the second set of ribs spaced about equidistantly apart. Typically, the second set of ribs is formed from a second sheet of ribbed permeate spacer fabric.

The first sheet of ribbed fabric and the second sheet of ribbed fabric are attached/secured to one another, so that the ribs in the second set of ribs are oriented substantially perpendicular to the ribs in the first set of ribs.

Examples of methods for attaching or securing the sheets together are ultrasonic welding, glueing, sewing, heat sealing and stapling, with ultrasonic welding being preferred.

The permeate spacer is produced by placing the second sheet of ribbed fabric on top of the first sheet of ribbed fabric, with the ribbed faces of each of the first and second sheets facing in the same direction. Preferably, the second sheet is then secured on top of the first sheet, such as via ultrasonic welding. Still yet another alternative method for producing the permeate spacer involves forming the spacer out of a single sheet of fabric or plastic, such as plastic film, by stamping or pressing the sheet itself to form the first and second sets of ribs.

The second set of ribs is formed from a piece of a second sheet of ribbed permeate fabric. The piece of the second sheet is situated at the distal end (i.e., the end farthest from the center tube) of the membrane envelope, and is affixed to the distal end on the ribbed planar surface of the first sheet of fabric so that the second set of ribs is oriented substantially perpendicular to the first set of ribs on the first sheet of ribbed fabric. The piece of the second sheet of fabric extends only a portion of the distance between the distal end of the membrane envelope and the center tube. For example, in an exemplary embodiment of the invention, the second sheet of fabric extends about 10 cm from the distal end (i.e., the end farthest from the center tube) of the membrane envelope towards the proximal end (closest the center tube) of the membrane envelope. The foregoing describes a permeate spacer according to the invention that is comprised of two pieces of ribbed fabric.

The permeate spacer of the invention is comprised of a substantially rectangular or square planar body. As is illustrated in FIGS. 4, 5 and 6, the permeate spacer 10 has first and second substantially planar faces 40 and 42; a first edge 44 and a second edge 46, wherein first and second edges 44 and 46 are substantially parallel to one another; a third edge 48 and a fourth edge 50, wherein third and fourth edges are substantially parallel to one another. When the permeate spacer is used in a membrane envelope, the edge of the envelope 2 corresponding to the permeate spacer's first edge 44 will be secured along the length of the center tube 20 of the membrane element.

In a preferred embodiment, only the first substantially planar face 40 is provided with raised ribs 52 and 54, as illustrated in FIGS. 4 and 5. In another embodiment, not illustrated here, both the first face 40 and the second face 42 are provided with ribs.

Each of the raised ribs 52 comprising the first set of ribs is substantially equidistant (spaced apart) from and substantially parallel to the other ribs in the first set. Each of the raised ribs 54 comprising the second set of ribs is substantially equidistant from and substantially parallel to the other ribs in the second set.

Within each set of ribs, the ribs must be close enough to one another to prevent the membrane envelope from sinking into the channels formed between the ribs, yet far enough apart to permit the flow of permeate through the channels. Typically, the ribs will be about 0.3 to about 2 mm apart. In an exemplary embodiment, the ribs define about 20 channels per inch. Notwithstanding, other channel sizes/rib spacings are within the scope of the invention

Within each set, each of the ribs is preferably the same height.

The first set of ribs 52 on planar face 40 is oriented so that the ribs are perpendicular to the longitudinal axis of the center tube, and substantially parallel to the center glue line of the membrane envelope. The second set of ribs 54 is oriented so that the ribs are parallel to the longitudinal axis of the center tube, and substantially perpendicular to the center glue line of the membrane envelope. More specifically, the ribs 52 in the first set of ribs are oriented substantially perpendicular to the ribs 54 in the second set of ribs.

The permeate spacer is used by sandwiching it within an osmosis membrane envelope, oriented so that the ribs in the first set of ribs of the permeate spacer are in a substantially perpendicular orientation relative to the center tube's longitudinal axis. The permeate spacer is oriented within the membrane envelope so that the second set of ribs is positioned as far away from the center tube as possible. The membrane envelope is then spirally wound around the center tube, as in standard spiral wound membrane envelopes. If the spiral membrane were unwound, the second set of ribs parallel to the center tube's longitudinal axis is on the edge of the permeate spacer that is the furthest away from, and parallel to, the center tube's longitudinal axis. Preferably the area of the permeate spacer having the first set of ribs is much greater than the area having the second set of ribs.

The relative orientations (i.e., perpendicular to one another) of the first set of ribs 52 and the second sets of ribs 54 in the permeate spacer 10 advantageously forces draw solution to flow to the end of the channels defined by the first set of ribs. In other words, draw solution is forced to flow from the center tube 20 to the edge 46 of permeate spacer 10 before it can flow laterally via the channels 55 in the second set of ribs 54. As a result, the permeate spacer described herein provides for substantially more uniform draw solution contact with the membrane than spacers of the prior art.

The following describes an example of how the permeate spacer may be produced, wherein the spacer is formed by joining together two pieces of ribbed spacer fabric that are oriented at a right angle with respect to one another. A first rectangular piece of ribbed permeate spacer fabric, such as Hornwood Style 1414 epoxy coated polyester permeate spacer, is joined with a second rectangular piece of a ribbed permeate spacer fabric. Joining is accomplished by placing the second piece of fabric on top of the first piece and the two are spot welded together, such as by ultrasonic welding. The second portion is formed by cutting a relatively narrow strip from another permeate spacer fabric, and adhering the strip at about a 90° angle to the first rectangular piece.

In another preferred embodiment illustrated in FIG. 7, a second set of ribs 54 is provided on the front face of the spacer 10, and a third set of ribs 57 is provided on the back face of the spacer. A third piece of ribbed fabric 62 having similar characteristics and measurements as the piece of the second sheet 63 described previously is employed. FIG. 7 illustrates an exploded view of a permeate spacer comprised of three pieces of ribbed fabric and having strips with ribs on both sides of the first sheet. The third piece of ribbed fabric 62 is situated on the second planar surface of the first sheet of ribbed fabric 60, directly opposite the second piece 63, which is itself situated on the first ribbed planar surface.

The permeate spacer illustrated in FIG. 7 is comprised of a first rectangular piece of ribbed permeate spacer fabric 60 and two smaller strips of ribbed spacer fabric 62 and 63, wherein the two small strips 62 and 63 are disposed in a perpendicular orientation relative to the first piece 60.

In the embodiment shown in FIG. 7, within each of the second set of ribs 54 and third set of ribs 57, the ribs are oriented substantially perpendicular to the center glue line 26 and to the ribs 52 in the first set of ribs, when the spacer 10 is in use in a membrane envelope 2. This embodiment may be made by joining two relatively narrow pieces or strips of ribbed spacer material to a first rectangular piece, with each narrow strip being joined to the front and back faces of the first rectangular piece.

As shown in FIG. 7, the permeate spacer 10 of the invention is comprised of a first rectangular planar body comprised of a first piece of ribbed spacer fabric 60 with ribs 52 that will be oriented perpendicular to the axis of the center tube when the spacer is in use. Two shorter pieces of ribbed fabric 62 and 63 are attached to either side of the first fabric piece 60. After attachment of the three fabric pieces by preferably ultrasonic spot welding together the distal edge of all three pieces, the welded fabric assembly comprises the spacer inside the membrane envelope. The thickness of the fabric should be in the range of about 0.3 to about 2 mm, and the distance between ribs should be in the range of about 0.3 to about 2 mm.

The ratio of the width of the first portion (i.e., the first set of ribs) to the second portion (i.e., the second set of ribs) is about 10:1 in a preferred embodiment.

The ribs 52 on the first rectangular planar body are oriented to spiral out from the center tube, and the ribs 54 in the second set of ribs on the strips will be at about a 90° angle relative to the ribs 52 in the first set of ribs. This arrangement of ribs provides a flow path laterally across the membrane envelope. Similarly, in the embodiment illustrated in FIG. 7, lateral flow within the membrane element is accomplished via channels 55 and 58.

This arrangement has the advantage that draw solution is forced to flow to the end of channel (i.e., is forced to flow from the center tube 20 to the edge 46 of permeate spacer 10) before it can flow laterally, which provides for more uniform draw solution contact with the membrane.

### EXAMPLE

The example of the invention that is shown in FIG. 3 through FIG. 6 was made by attaching two short and narrow strips of ribbed permeate spacer fabric (Hornwood Style 1414 epoxy coated polyester permeate spacer) to the end of another permeate spacer having a larger surface, wherein the ribs on the two short and narrow strips are oriented at about a 90-degree angle relative to the ribs on the permeate spacer having a larger surface. The permeate spacer of the invention may use ribbed permeate spacer fabric having a thickness in the range of about 0.3 to about 2 mm.

The performance of the permeate spacer design was tested by rolling three spiral elements, Elements 1, 2 and 3. Each of the three elements had a single membrane leaf with dimensions of 1 meter by 1 meter (effective area after gluing is about 1.6 m²), and all had identical feed spacers (HTI corrugated feed spacers of about 2.5 mm thickness). The membranes in each were HTI embedded mesh CTA FO membrane.

In Element 1, the permeate spacer (draw solution spacer) was a single Hornwood 1414. Thus, Element 1 represents the prior art.

Element 2 was built in accordance with the invention. In Element 2, the permeate spacer was a single Hornwood 1414 spacer with 6″ wide strips of cross direction Hornwood 1414 on both the first and second planar faces (i.e., on the front and back), at the edge of the spacer furthest from the edge which corresponds to the edge of the membrane envelope that will be attached to the center tube of the membrane element.

Element 3 had three full size Hornwood 1414 spacers stacked together in the membrane envelope/leaf. Thus, the two outer spacers have ribs oriented to spiral out in a perpendicular direction from the center tube, and the center spacer has ribs oriented so that they are substantially perpendicular to the to the ribs in the outer spacers.

All tests were run with a 19 psi feed pressure, a 4 psi feed channel pressure drop, and the brine channel (i.e., the center tube through which the draw solution flows) had 10 psi at the inlet and 0 psi at the outlet. The feed solution, which is the solution that is fed through the feed spacer, was either tap water (Test 1) or tap water with NaCl, referred to as a “brackish” water feed. The draw solution, which is fed through the center tube and then travels into the membrane envelope/leaf, was a sodium chloride solution. The results of these tests are shown in Table 1.

TABLE 1

| | Element 1 | Element 2 | Element 3 |
|---|---|---|---|
| Test 1 - Tap Water Feed | | | |
| Feed Conductivity (ms/cm) | 0.7 | 0.9 | 3 |
| Draw Conductivity (ms/cm) | 44 | 50 | 56 |
| Draw Flow Rate (ml/min) | 360 | 410 | 2300 |
| Membrane Flux (LMH) | 4.0 | 5.7 | 7.5 |
| Temperature (° C.) | 27 | 28 | 24 |
| Test 2 - Brackish Water Feed | | | |
| Feed Conductivity (ms/cm) | 28 | 25 | 35 |
| Draw Conductivity (ms/cm) | 58 | 54 | 55 |
| Draw Flow Rate (ml/min) | 320 | 400 | 1640 |
| Membrane Flux (LMH) | 1.0 | 2.7 | 2.5 |
| Temperature (° C.) | 26 | 26 | 25 |

### Description of the Results

Feed conductivity refers to the salt concentration in the feed water. Draw conductivity refers to the salt concentration at the inlet to the interior of the membrane envelope. Draw Flow Rate refers to the rate (liters per minute) that draw solution is introduced into the center tube. Membrane Flux refers to the rate that water crosses through the membrane from the feed to the draw.

In Test 1, using tap water feed with a low salinity, the difference in membrane flux between Element 1 and Element 2 can be explained by the improved flow distribution of the draw solution in Element 2.

In Test 1, the high membrane flux of Element 3 is attributable to the draw solution flow being 5 times faster, due to an increase in the number of channels resulting from the use of 3 permeate spacers stacked together, which overcomes any maldistribution of draw solution flux. Maldistribution of draw solution flux refers for the tendency of flow to slow down considerably at the perimeter of the envelope, and to slow down or practically stop in the corners of the envelope that are distal from the center tube.

In Test 2, using feed with a higher salinity than that used in Test 1, the difference in performance (membrane flux) between Element 1 and Element 2 is even more pronounced than it was in Test 1. This shows the critical importance of draw solution flow distribution made possible by the permeate spacer of the present invention. Element 3 performs well, but again the high flow velocity of the draw solution overcomes any uneven flow distribution.

### Conclusions

The Element 2 design delivers good performance while cutting the required draw solution pumping by more than a factor of four, reducing the thickness of the permeate channel by a factor of almost 3, thus allowing more membrane leaves per element, and reducing the cost of permeate spacer by almost a factor of three.

Accordingly, described herein is a permeate spacer for use in an osmosis membrane element, comprising: a substantially planar body having a first edge, a second edge, a third edge and a fourth edge, and a first face and a second face; the first face is provided with a first set of ribs having ribs oriented substantially parallel to one another, and substantially parallel to the third and fourth edges of the planar body; and a second set of ribs having ribs oriented substantially parallel to one another, and substantially parallel to the first and second edges of the planar body; wherein the ribs in the first set of ribs are oriented substantially perpendicular to the ribs in the second set of ribs.

In a more specific embodiment, the second face of the substantially planar body of the permeate spacer is provided with a third set of ribs having ribs oriented substantially parallel to one another and substantially parallel to the first and second edges of the planar body.

In another embodiment, the first set of ribs and the second set of ribs do not overlap.

In a preferred embodiment, the permeate spacer has a ratio of about 10:1 of the first set of ribs to the second set of ribs.

The permeate spacer is used in an osmosis membrane element, in which the element is comprised of a permeate spacer sandwiched between two leaves of a membrane envelope, wherein the permeate spacer comprises a substantially planar body having a first edge, a second edge, a third edge and a fourth edge, and a first face and a second face; the first face is provided with a first set of ribs having ribs oriented substantially parallel to one another, and substantially parallel to the third and fourth edges of the planar body; and a second set of ribs having ribs oriented substantially parallel to one another, and substantially parallel to the first and second edges of the planar body; wherein the ribs in the first set of ribs are oriented substantially perpendicular to the ribs in the second set of ribs, and wherein the two leaves of the membrane element are adjacent the first and second faces of the planar body.

In another embodiment of the osmosis membrane element, the second face of the planar body of the permeate spacer is provided with a third set of ribs having ribs oriented substantially parallel to one another and substantially parallel to the first and second edges of the planar body.

Generally speaking, it osmosis membrane element will further comprise a center tube secured to the first edge of the planar body.

The permeate spacer is used in an osmosis membrane element. It is particularly useful in methods for conducting forward osmosis or pressure retarded osmosis. For example, a forward osmosis method involves causing draw solution to flow within a membrane element having a permeate spacer, wherein the permeate spacer comprises a substantially planar body having a first edge, a second edge, a third edge and a fourth edge, and a first face and a second face; the first face is provided with a first set of ribs having ribs oriented substantially parallel to one another, and substantially parallel to the third and fourth edges of the planar body; and a second set of ribs having ribs oriented substantially parallel to one another, and substantially parallel to the first and second edges of the planar body; wherein the ribs in the first set of ribs are oriented substantially perpendicular to the ribs in the second set of ribs.

In another method, the second face of the planar body of the permeate spacer is provided with a third set of ribs having ribs oriented substantially parallel to one another and substantially parallel to the first and second edges of the planar body.

1. A permeate spacer for use in an osmosis membrane element, comprising:
a substantially planar body having a first edge, a second edge, a third edge and a fourth edge, and a first face and a second face;
the first face is provided with
a first set of ribs having ribs oriented substantially parallel to one another, and substantially parallel to the third and fourth edges of the planar body; and
a second set of ribs having ribs oriented substantially parallel to one another, and substantially parallel to the first and second edges of the planar body;
wherein the ribs in the first set of ribs are oriented substantially perpendicular to the ribs in the second set of ribs.

2. The permeate spacer of claim 1, wherein the second face is provided with a third set of ribs having ribs oriented substantially parallel to one another and substantially parallel to the first and second edges of the planar body.

3. The permeate spacer of claim 1, wherein the first set of ribs and the second set of ribs do not overlap.

4. The permeate spacer of claim 1, having a thickness in the range of about 0.3 to about 2 mm.

5. The permeate spacer of claim 1 wherein the ribs in at least the first or second set of ribs are spaced about 0.3 to about 2 mm apart.

6. The permeate spacer of claim 1, having a ratio of about 10:1 of the first set of ribs to the second set of ribs.

7. An osmosis membrane element comprising:
a permeate spacer sandwiched between two leaves of a membrane envelope, wherein the permeate spacer comprises a substantially planar body having a first edge, a second edge, a third edge and a fourth edge, and a first face and a second face;
the first face is provided with
a first set of ribs having ribs oriented substantially parallel to one another, and substantially parallel to the third and fourth edges of the planar body; and
a second set of ribs having ribs oriented substantially parallel to one another, and substantially parallel to the first and second edges of the planar body;
wherein the ribs in the first set of ribs are oriented substantially perpendicular to the ribs in the second set of ribs,
and wherein the two leaves of the membrane element are adjacent the first and second faces of the planar body.

8. The membrane element of claim 7, wherein the second face of the planar body of the permeate spacer is provided with a third set of ribs having ribs oriented substantially parallel to one another and substantially parallel to the first and second edges of the planar body.

9. The membrane element of claim 8, further comprising a center tube secured to the first edge of the planar body.

10. A method for conducting forward osmosis or pressure retarded osmosis, comprising causing draw solution to flow within a membrane element having a permeate spacer, wherein the permeate spacer comprises
a substantially planar body having a first edge, a second edge, a third edge and a fourth edge, and a first face and a second face;
the first face is provided with
a first set of ribs having ribs oriented substantially parallel to one another, and substantially parallel to the third and fourth edges of the planar body; and
a second set of ribs having ribs oriented substantially parallel to one another, and substantially parallel to the first and second edges of the planar body;
wherein the ribs in the first set of ribs are oriented substantially perpendicular to the ribs in the second set of ribs.

11. The method of claim 10, wherein the second face of the planar body of the permeate spacer is provided with a third set of ribs having ribs oriented substantially parallel to one another and substantially parallel to the first and second edges of the planar body.
